(19) United States
(12) Patent Application Publication
(10) Pub. No.: US 2025/0368352 A1
(43) Pub. Date: Dec. 4, 2025

(54) PROTECTIVE DEVICE FOR PROTECTING A PROTRUDING AERIAL PART OF AN ANEMOBAROMETRIC SENSOR

(71) Applicant: THALES, MEUDON (FR)

(72) Inventors: Jocelyn BÊ, VENDOME (FR); Nicolas MAURIN, VENDOME (FR)

(21) Appl. No.: 19/108,108

(22) PCT Filed: Sep. 4, 2023
(86) PCT No.: PCT/EP2023/074178

§ 371 Date: Mar. 22, 2025

(30) Foreign Application Priority Data
Sep. 6, 2022 (FR) 2208883

(51) Int. Cl. B64D 45/00; B64F 1/00; G01P 5/165

(52) U.S. Cl. CPC B64D 45/00; B64F 1/005; G01P 5/165

(57) ABSTRACT

A protective device for protecting a protruding aerial part of an anemobarometric sensor includes a sheath to protect the protruding part, a gripping handle including a bar that can be grasped between the thumb and the other fingers, and at least one locking element for locking the protective device on the body of the anemobarometric sensor, the protective device not covering up attachment holes intended for attaching the body of the sensor to an aircraft.

### CROSS-REFERENCE TO RELATED APPLICATIONS

This application is a National Stage of International patent application PCT/EP2023/074178, filed on Sep. 4, 2023, which claims priority to foreign French patent application No. FR 2208883, filed on Sep. 6, 2022, the disclosures of which are incorporated by reference in their entireties.

### FIELD OF THE INVENTION

The invention relates to a protective device for protecting a protruding aerial part of an anemobarometric sensor.

The technical field of the invention is the protection of protruding anemobarometric aeronautical sensors, in particular during storage, fitting and maintenance operations.

The technical field of the invention is that of protruding anemobarometric sensors, for example clinometric sensors such as AoA (Angle of Attack) probes, SSA (Side Slip Angle) probes, multifunction sensors of the type comprising a sensor body on which a wind vane is rotatably mounted, or pitot tubes.

### BACKGROUND

One problem encountered with protruding anemobarometric sensors, particularly on assembly and maintenance lines, lies in the handling of the sensor by its protruding part, whereas this part is not designed for and is often not the right size for this purpose. When the stresses applied are high, such handling can result in the sensor not working properly, or in the protruding part becoming deformed.

By design, the protruding part, such as a wind vane, is necessarily accessible on the sensor and naturally presents a point for grasping the sensor, in particular when it is being put in place on the fuselage, i.e. fitted, but also during maintenance or storage. In addition, the protruding part is also exposed to accidental stresses such as knocks, tooling, or impacts caused by the installation of a passenger ramp.

Such unintended handling leads to the need for repairs and additional costs which are significant.

The known prior art, although it provides protection for sensors, does not however provide for handling thereof and requires the use of specific attachments on the fuselage. The specific orientation of protruding anemobarometric aeronautical sensors is also not covered by the prior art.

Protective devices for protecting a protruding aerial part of an anemobarometric sensor are known. One example is that disclosed in document FR 2864228, which relates to a protective device for protecting a sensor rigidly secured to an aircraft wall.

Such a protective device has several limitations, for example:
it requires drilling into the aircraft wall;
the sensor equipped with this device cannot be dismantled because the attachment screws are covered;
it is not possible to transport the sensor equipped with this protective device; and
it is not possible to orient the protruding part of the sensor, such as a wind vane, in such a way as to invalidate measurements if the sensor is in a position different from its functional position for taxiing/takeoff such that the aircraft considers the sensor to be malfunctioning in the event of failure to remove the protective device prior to takeoff.

### SUMMARY OF THE INVENTION

It is an aim of the invention to overcome the problems mentioned above, and in particular to improve the protection provided for the sensor during installation on an aircraft while avoiding excessive oversizing of the mechanical part of the sensor and guaranteeing the safety of the aircraft in the event that the protection is forgotten.

According to one aspect of the invention, there is proposed a protective device for protecting a protruding aerial part of an anemobarometric sensor comprising a sheath configured to protect said protruding part, a gripping handle comprising a bar that can be grasped between the thumb and the other fingers, and at least one locking element for locking the protective device on the body of the anemobarometric sensor, the protective device not covering up attachment holes intended for attaching the body of the sensor to an aircraft.

In one embodiment, the locking element is configured to place the protruding aerial part, which is rotatable, of the anemobarometric sensor, such as a wind vane, in a position different from its functional position for taxiing/takeoff of an aircraft equipped with such a sensor, such that the aircraft considers the sensor to be malfunctioning when the sensor is configured to determine an angular position of the protruding aerial part, in the event of failure to remove the protective device before takeoff.

According to one embodiment, the locking element is a device for locking by expansion in the body of the sensor.

Alternatively, the locking element is a device for locking by ball lock in the body of the sensor.

Alternatively, the locking element is a device for locking by suction cup on the aircraft interface plate of the sensor or on the external portion of the body of the sensor.

In one embodiment, the locking element being a device for locking by suction cup, the protective device comprises an indicator configured to indicate the front of an aircraft in such a way as to place the protruding aerial part of the anemobarometric sensor, which is rotatable, such as a wind vane, in a position different from its functional position for taxiing/takeoff of an aircraft equipped with such a sensor, such that the aircraft considers the sensor to be malfunctioning.

According to one embodiment, the protective device comprises a removable annular protection configured to protect screws for attaching the sensor to the aircraft.

In one embodiment, the removable annular protection comprises a seal to block the passage of sand and liquid.

For example, the seal is circular.

According to one embodiment, the protective device is made from a material comprising a composite or metal.

### BRIEF DESCRIPTION OF THE DRAWINGS

The invention will be understood more clearly on studying some embodiments described by way of non-limiting examples and illustrated by the attached drawings in which:

FIG. 1 schematically shows a top view of an anemobarometric sensor provided with a protruding aerial part, such as an AoA probe, according to one aspect of the invention;

FIG. 2 schematically shows a side view of an anemobarometric sensor provided with a protruding aerial part, such as an AoA probe, according to one aspect of the invention;

FIG. 3 schematically shows a top view of a protective device for protecting a protruding aerial part of an anemobarometric sensor, according to another aspect of the invention;

FIG. 4 schematically shows a sectional view of a protective device for protecting a protruding aerial part of an anemobarometric sensor, the anemobarometric sensor being in side view, according to one aspect of the invention;

FIG. 5 schematically shows a sectional view of a device for locking by expansion of a protective device for protecting a protruding aerial part of an anemobarometric sensor, according to one aspect of the invention;

FIG. 6 schematically shows a sectional view of a device for locking by ball lock of a protective device for protecting a protruding aerial part of an anemobarometric sensor, according to one aspect of the invention; and

FIG. 7 schematically shows a sectional view of a device for locking by suction cup of a protective device for protecting a protruding aerial part of an anemobarometric sensor, according to one aspect of the invention.

In all of the figures, elements designated by identical references are similar.

### DETAILED DESCRIPTION

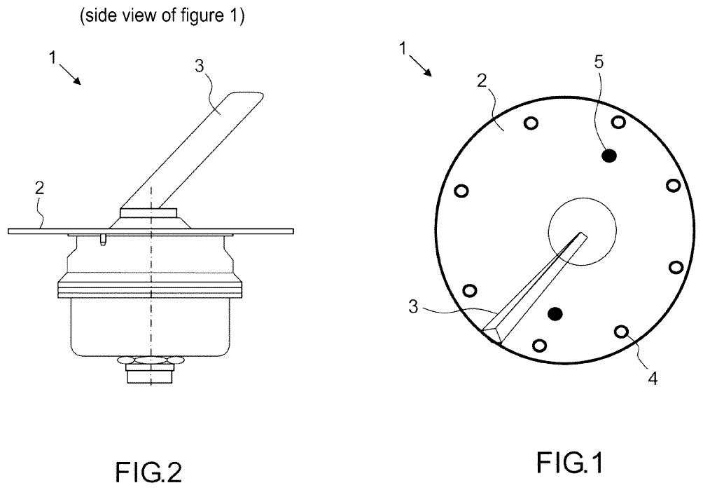

FIG. 1 and FIG. 2 respectively show a top view and a side view of an anemobarometric sensor having a protruding aerial part, in this case an AoA probe, as found in the prior art.

A sensor 1, in this case an AoA probe, for an aircraft, comprises a sensor body 2, on which is mounted a protruding aerial part, in this case a wind vane 3, which is rotatable.

The sensor 1 comprises attachment holes 4 intended for attaching the sensor 1 on an aircraft. The sensor 1 may also comprise attachment holes 5 intended for attaching a protection for the sensor 1, such as that disclosed in document FR 2864228.

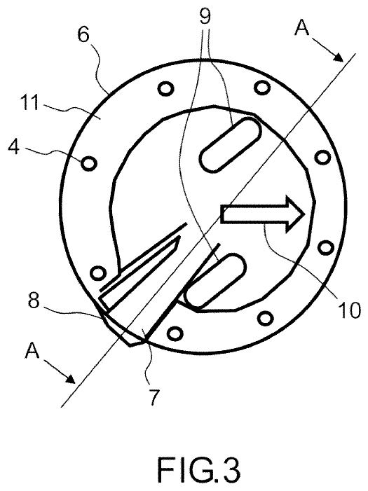

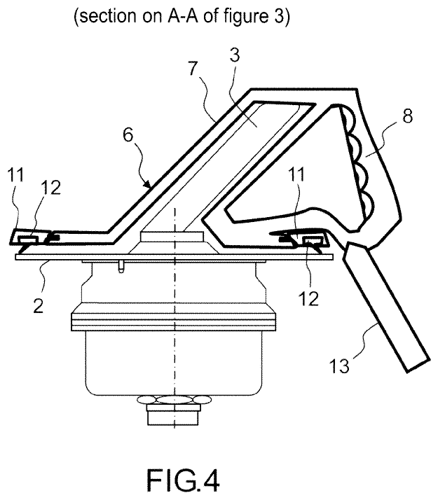

FIG. 3 and FIG. 4 respectively show a top view and a sectional view of a protective device for protecting a protruding aerial part of an anemobarometric sensor, according to another aspect of the invention.

A protective device 6 for protecting a protruding aerial part 3 of an anemobarometric sensor 1 comprises a sheath 7 configured to protect said protruding part 3, a gripping handle 8 comprising a bar that can be grasped between the thumb and the other fingers, and at least one locking element 9 for locking the protective device 6 on the body 2 of the anemobarometric sensor 1. The protective device 6 does not cover up attachment holes 4 intended for attaching the body 2 of the sensor 1 to an aircraft.

Thus, the attachment screws placed in the attachment holes 4 to attach the body 2 of the anemobarometric sensor 1 are accessible even when the protective device 6 is locked on the body 2 of the sensor 1.

A locking element 9 may be a device for locking by expansion in the body of the sensor, a device for locking by ball lock in the body of the sensor, or a device for locking by suction cup on the aircraft interface plate of the sensor or on the external portion of the body 2 of the sensor.

When the locking element or elements 9 are devices for locking by suction cup, the protective device 6 may comprise an indicator 10, such as an arrow 10, indicating the front of the aircraft and intended to orient the wind vane at a preferred angle, in a position different from its functional position for taxiing/takeoff of an aircraft equipped with such a sensor, such that the aircraft considers the sensor to be malfunctioning in the event of failure to remove the protective device 6 before takeoff. For this purpose, the sensor 1 is configured to determine an angular position of the protruding aerial part 3, which is rotatable.

The protective device 6 may comprise a removable annular protection 11 configured to protect the screws for attaching the sensor to the aircraft. Being removable, the removable annular protection 11 allows access to the attachment screws placed in the attachment holes 4 to attach the body 2 of the anemobarometric sensor 1 even when the protective device 6 is locked on the body 2 of the sensor 1.

The removable annular protection 11 may comprise a seal, for example a circular seal 12, to block the passage of sand and liquid.

A tag 13, sometimes referred to as an RBF (Remove Before Flight) tag, may indicate to operators that the protective device 6 must be removed before the aircraft is flown.

FIG. 5 schematically shows a locking element 9 of the protective device 6, which is a device for locking 9 by expansion in the body 2 of the sensor 1. The device for locking 9 by expansion comprises a locking/unlocking control element 14, in this case a lever. The device for locking 9 by expansion comprises an element 15 for immobilization on the body 2 of the anemobarometric sensor 1.

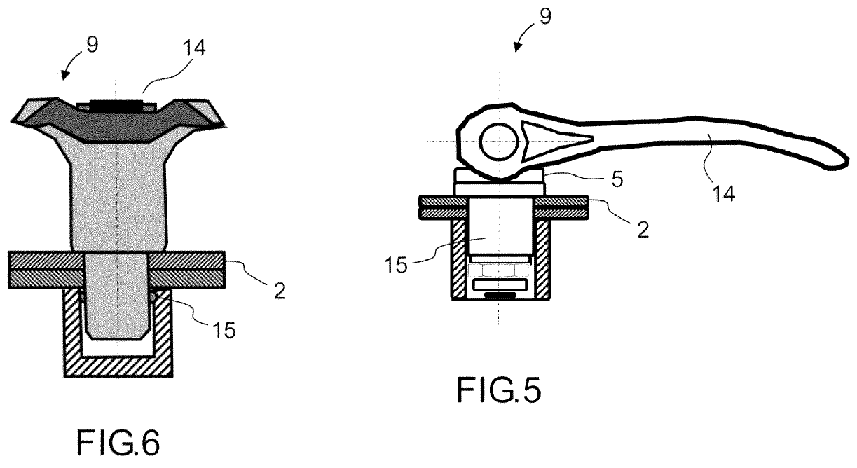

FIG. 6 schematically shows a locking element 9 of the protective device 6, which is a device for locking 9 by ball lock in the body 2 of the sensor 1. The device for locking 9 by ball lock comprises a locking/unlocking control element 14, in this case a push button 14. The device for locking 9 by ball lock comprises an element 15 for immobilization on the body 2 of the anemobarometric sensor.

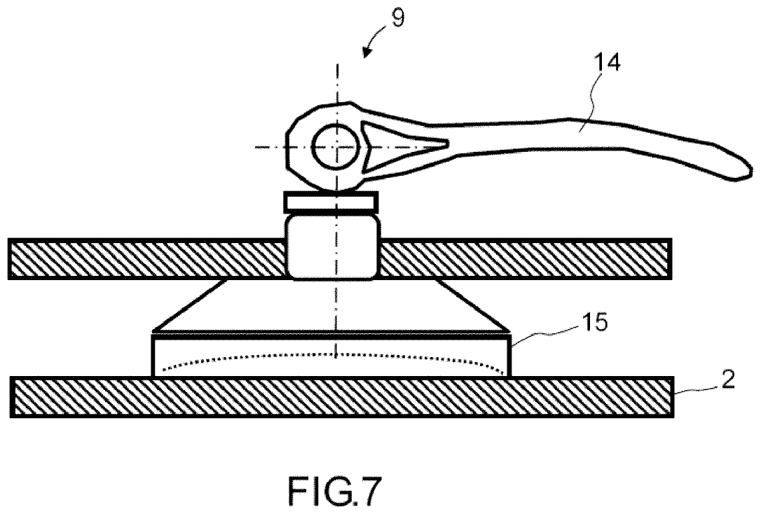

FIG. 7 schematically shows a locking element 9 of the protective device 6, which is a device for locking 9 by suction cup on the body 2 of the sensor 1. The device for locking 9 by suction cup comprises a locking/unlocking control element 14, in this case a lever. The device for locking 9 by suction cup comprises an element 15 for immobilization on the body 2 of the anemobarometric sensor, in this case a suction cup.

1. A protective device for protecting a protruding aerial part of an anemobarometric sensor comprising a sheath configured to protect said protruding part, a gripping handle comprising a bar that can be grasped between the thumb and the other fingers, and at least one locking element for locking the protective device on the body of the anemobarometric sensor, the protective device not covering up attachment holes intended for attaching the body of the sensor to an aircraft.

2. The protective device as claimed in claim 2, wherein the locking element is configured to place the protruding aerial part, which is rotatable, of the anemobarometric sensor in a position different from its functional position for taxiing/takeoff of an aircraft equipped with such a sensor, such that the aircraft considers the sensor to be malfunctioning when the sensor is configured to determine an angular position of the protruding aerial part, in the event of failure to remove the protective device before takeoff.

3. The protective device as claimed in claim 2, wherein the locking element is a device for locking by expansion in the body of the sensor.

4. The protective device as claimed in claim 2, wherein the locking element is a device for locking by ball lock in the body of the sensor.

5. The protective device as claimed in claim 2, wherein the locking element is a device for locking by suction cup on the aircraft interface plate of the sensor or on the external portion of the body of the sensor.

6. The protective device as claimed in claim 5, comprising an indicator configured to indicate the front of an aircraft.

7. The protective device as claimed in claim 1, comprising a removable annular protection configured to protect screws for attaching the sensor to the aircraft.

8. The protective device as claimed in claim 7, wherein the removable annular protection comprises a seal to block the passage of sand and liquid.

9. The protective device as claimed in claim 8, wherein the seal is circular.

10. The protective device as claimed in claim 1, made from a material comprising a composite or metal.
